(19) United States
(12) Patent Application Publication
(10) Pub. No.: US 2004/0018263 A1
(43) Pub. Date: Jan. 29, 2004

(54) Apparatus useful for continuous forming of thermoplastic material and method for use thereof

(76) Inventors: Rami Hashimshony, Pardes Hanna (IL); Dudu Havazelet, Emek Izrael (IL)

Correspondence Address: BIRCH STEWART KOLASCH & BIRCH, PO BOX 747, FALLS CHURCH, VA, 22040-0747, US

(21) Appl. No.: 10/201,648

(22) Filed: Jul. 24, 2002

(51) Int. Cl. B29C 47/00

(52) U.S. Cl. 425/113; 264/145; 425/363; 425/382.3

(57) ABSTRACT

The present invention relates to the art of continuous forming of elongated strip-like products made of thermoplastic material, and more specifically to apparatus and method to forming said thermoplastic material over a substantial portion of the circumference of a forming roll. The present invention is specifically related to the art of forming agricultural products, and especially for the production of drip irrigation strip which may be used for installing in the inner side of a tube or to be folded to form an irrigation tube.

### FILED OF THE INVENTION

The present invention relates to the art of continuous forming of elongated strip-like products made of thermoplastic material, and more specifically to apparatus and method to forming said thermoplastic material over a substantial portion of the circumference of a forming roll. The present invention is specifically related to the art of forming agricultural products, and especially for the production of drip irrigation strip which may be used for installing in the inner side of a tube or to be folded to form an irrigation tube.

### BACKGROUND OF THE INVENTION

Strip-like polymeric products are commercially manufactured by extruding thermoplastic materials, and immediately in a subsequent step embossing the obtained extruded strip by means of forcing the same throughout a singular space (hereto defined as the embossing lane) defined by a set of cooperating forming rolls.

Said embossing lane is characterized in the state of the art by a relatively short and gradually linear passageway in which the extruded strip, usually still in its plastic state, is passing longitudinally at a controllable velocity, to form the desired shape and cross section. Higher the embossment velocity (the linear velocity, e.g., the rate in which said strip is passing said embossment pathway), higher is the economic feasibility of the process. Nevertheless, said cooperated forming rolls are defining no more then a short embossing lane of low surface area, providing thus for an acknowledged low embossing-efficiency, and subsequently to a considerable slow embossment velocity (i.e. linear velocity), and hence to a process of relatively low technological and economical feasibility.

Along the years, modifications and alternations of the hereto described basic concept where suggested. As such is the U.S. Pat. No, 5,478,516 to Malm et al., presenting a method of forming an elongated trim strip product, comprising interalia the steps of extruding the thermoplastic material, embossing the same and forming a trim member by the known means of the conventional set of two cooperated forming rolls, of the just before cooling the processed material below its plastic state. It is reflected that increasing the surface area (and the effective time period) of the processed material in the embossing lane shall significantly increase the efficiency of the method. Much similarly, U.S. Pat. No, 4,269,884 to DellaVecclhia et al., presents a laminate of reinforced thermoplastic polymer sheets made by the method of embossing more then one sheet-layer by means of plurality of forming rolls. Here again, each of the described embossing steps is containing a singular and short embossing lane, provided by two adjacent forming rolls.

U.S. Pat. No. 6,120,624 to Harrold et at. presents a method and apparatus for forming agricultural drip tape comprising an irrigation hose and isolated flow paths located at predetermined longitudinally spaced locations. Said apparatus is having means to extrude molten material, and to form an extrusion die having discrete grooves. Then, the obtained sheet is trimmed to a desired width and then it slit at predetermined longitudinally spaced locations, in order to provide outlet openings. Later on, a second strip or bead is extruded onto a rotation wheel, which has specific groove geometry, etched on its periphery. As the form wheel rotates, it brings the extruded bead into a contact with a continuous belt, which compresses the molten extruded into the groove configuration on the periphery of the wheel. Thus, discrete grooves of isolated flow paths are enabled. Is this invention, the forming wheel is engaged with a continues belt for about 270° of the circumference of the wheel, only for the purpose of processing the secondary flow path and not for processing the primary thermoplastic tape of said irrigation hose.

### SUMMARY OF THE INVENTION

It is thus the scope of the present invention to provide an apparatus useful for continuous processing of thermoplastic materials to form strip-like products having a predetermined shape and cross section. Said apparatus comprising at least one forming toll cooperated with at least one endless belt (ide., cooperated belt). The apparatus is additionally comprising means to roll the at least one cooperated belt adjacent a significant portion (i.e., more than about 20°) of the outer circumference of the at least one said forming roll, so the inner circumference of said cooperated belt and the said outer circumference of the forming belts are defining a gradually circular embossing lane. Preferably the said apparatus is having means to regulate the temperature of the said strip-like product along its course in said circular embossing lane, wherein the product has been cooled to about its solidification state along said embossing lane at the time it rotate throughout said embossing lane. In addition, the aforementioned apparatus is characterized that the said thermoplastic material to be formed is passing longitudinally throughout said gradually circular embossing lane in the manner said strip-like product is obtained with the predetermined shape and cross section.

According one embodiment of the invention, the apparatus defined above is characterized that said cooperated elastic belt engages 180° to 320° of the outer circumference of the forming roll. More specifically, the engagement is for about 220° to 280°, and particularly 270° of the outer circumference of the forming roll. This respectively long and novel lane enables the thermoplastic material to cool relatively slowly, comparing the embossment techniques know in the art, thus to attain slowly its solid state and its exact predetermined dimensions.

According to another embodiment of the present invention, the apparatus defined above is containing at least two embossing lanes. Those lanes characterized by a forming cycle comprising means (i) to pull the viscoelastic product in its way outside the extruder; (ii) to dry said viscoelastic material, (iii) to form or to emboss said material and simultaneously, and lastly, (iv) to cool said strip-like material to about its solidification state.

According to another embodiment of the present invention, the apparatus defined above is adapted to reinforce the obtained strip-like product by at least one sheet member or cable adapted to attach the said strip-like product chemically or physically in the manner that both the thermoplastic material to be embossed and the said reinforcing means are allowed to pass together in the gradually circular embossing lane so hybrid or laminated reinforced product is obtained.

It is thus in the scope of the present invention to provide the apparatus defined above, additionally having means to form a trimmed strip-like product. Said trim is preferably selected from a logo, lettering or any predetermined artistic feature.

It is particularly in the scope of the present invention wherein the aforementioned apparatus is adapted to produce ingredients of a drip emitter, and thus having means to form a strip-like product comprising plurality of water conduits, and especially wherein said water conduits comprising at least one-plurality inlet nozzles, pressure reducing pathways, and outlet nozzles,

According another preferred embodiment of the present invention, the hereto presented apparatus is having a plurality of forming rolls, engaged by at least one cooperated endless belt, heaving means to produce more then one strip-like product at the time. Much similarly, it is in the scope of the present invention wherein said apparatus is having a plurality of forming rolls engaged by at least one cooperated endless belt, heaving means to produce more than one strip-like product at the time.

Also in the scope of the present invention is a strip-like product, made of thermoplastic material, wherein the weight of the cross-section of strip-like product is not changed along its length more than about 10%.

It is still another object of the present invention to provide usefull a strip-like product made of thermoplastic material formed by means of the apparatus defined above. More specifically, a drip irrigation emitter, having a strip-like structure.

It is another object of the present invention to provide useful a method for processing thermoplastic material, having a plastic state by the apparatus defined above, comprising the steps of pushing the said material throughout a gradually circular course of the embossing lane while it is cooled to its solidification state, so a strip-like product is obtained,

Thus, it is also in the scope of the present invention to provide a useful method for forming a trim strip-like product defined above, additionally comprising the step of forming said trim in the embossing lane before a significant cooling of the thermoplastic material in process.

Finally, a, method for forming the aforementioned elongated strip-like product is provided useful, wherein comprising the steps of (a) obtaining extruded viscoelastic melt; (b) drying said melt and (c) forming said melt. Said forming of the melt is provided simultaneously by the following at least three steps. (i) embossing by means of the forming role and the continuous belt; (ii) cooling said formed material to below its melting temperature; and (iii) pulling said material under controlled tension. An additional step is applicable, wherein the tension of the obtained strip-like product is controlled after it exits the forming rolls.

### BRIEF DESCRIPTION OF THE FIGURES

FIG. 1 schematically illustrates commercially available apparatus for embossing thermoplastic materials comprising a set of cooperating forming rolls having a singular and short embossment lane.

FIG. 2 schematically illustrates the apparatus according to the present invention, useful for embossing thermoplastic material over the circumference of a forming roll, enabling a relatively long and effective embossment lane.

FIG. 3 presents a side view of one embodiment of the present invention, in which the extruded strip is forced to roll over the external circumference of a forming roll by means of a forming belt rolling over the said external circumference of the forming roll.

FIG. 4 presents the forming cycle according to the present invention, comprising the steps of melting, cooling, drying, forming, cooling and pulling under controlled tension.

### DETAILED DESCRIPTION OF THE FIGURES

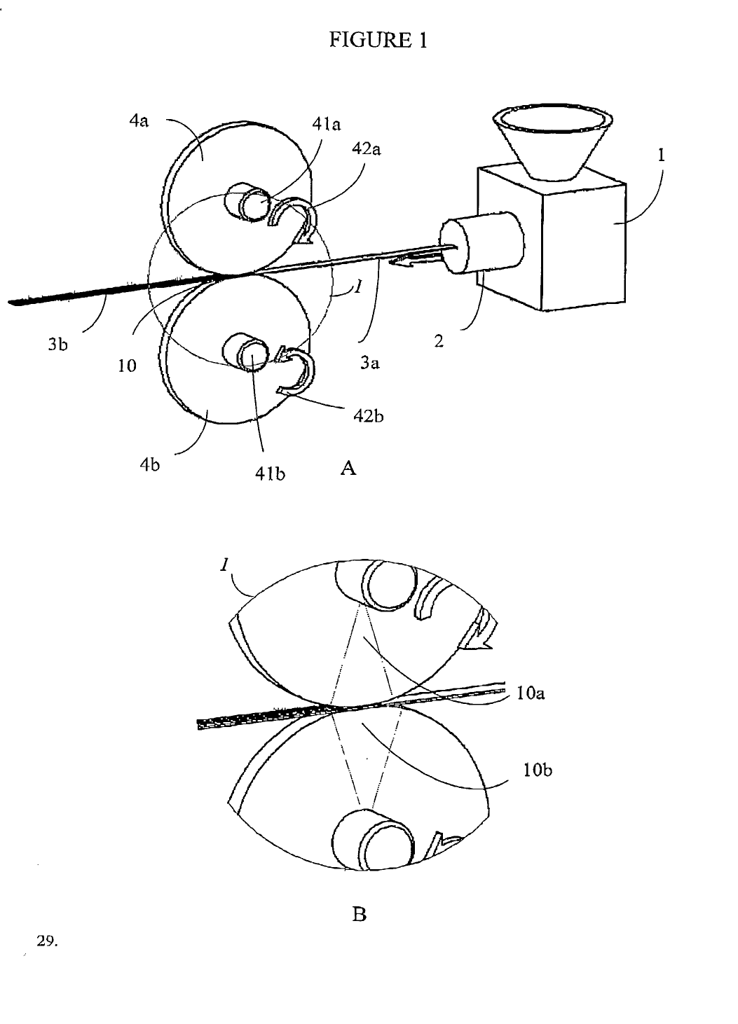

Reference is made now to FIG. 1, presenting a generalized scheme of a well known method of producing strip-like polymeric products. In scheme 1A, an extruder (1) is presented, wherein a die of a thermoplastic material is introduced to obtain a strip of extruded material (3a) flowing via the extruder opening (2). The width, shape and cross-section of said feed (3a) is to be changed by means of a plurality of cooperated forming rolls (4a) and (4b), each of which is having an axle (41a) (41b) and means to roll is predetermined course (42a) (42b). The material in process is forced to pass throughout a relatively short and gradually linear passageway (10) in which the extruded strip, usually still in its plastic state, is passing longitudinally at a controllable velocity, to form the desired shape and cross section (3b). Scheme 1B is a detailed view (see view 1) of the said passageway (10), showing the adjacent forming rolls (4a) and (4b), defining a short passageway to which strip (3a) enters and (3b) leaves. The effective width of the formed embossing lane (1Oa) is significantly short and stand for less then 1/16 of the circumference of each of the forming rolls (4a) and (4b).

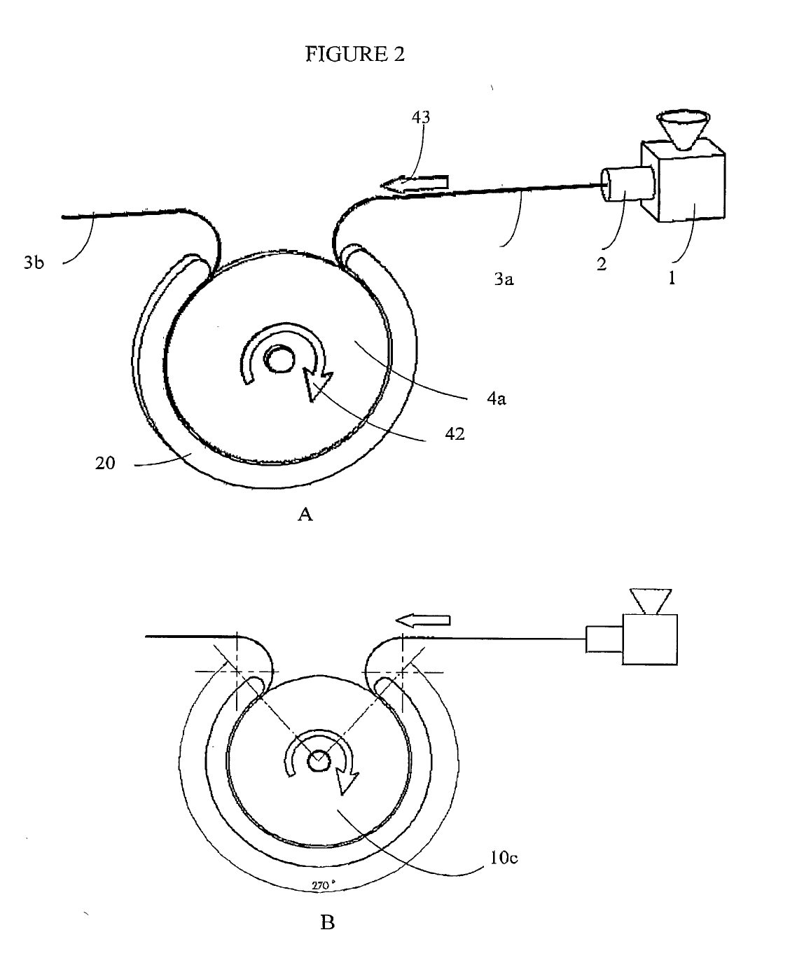

Reference is made now to FIG. 2A, presenting the same generalized scheme whereat a die of thermoplastic material is extruded (1) and ejected via outlet (2) to form a feed strip (3a) pushing in the direction (43). Said feed strip is embossed according the present invention, i.e., along the gradually portion of the outer circumference of one forming roll (4a), to yield with the desired strip-like product (3b). Scheme 2B presents a closer view to said one forming rolls, showing that the effective width of the formed embossing lane (1Oc) is significantly longer and stands for more then 5/6 of the circumference of each of the aforementioned forming rolls (4a).

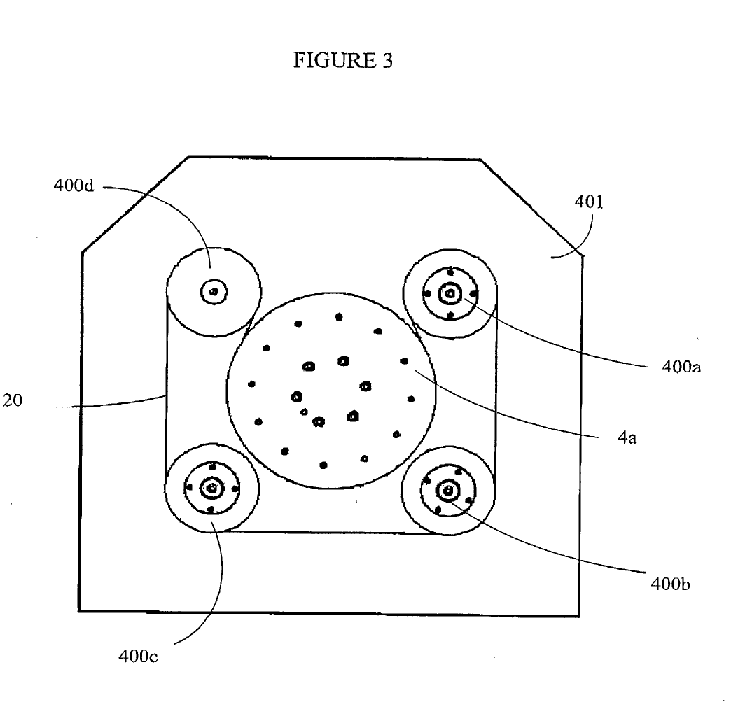

FIG. 3 presents one particular embodiment of the present invention. This apparatus comprising at least one forming roll (4a); and at least one cooperated belt (20). Said belt is having means to engage the forming roll, e.g., to roll adjacent a significant portion of the outer circumference of the said forming roll, so the inner circumference of said cooperated belt and the said outer circumference of the forming belts are defining the aforementioned gradually circular embossment lane (10). According to this embodiment as presented in FIG. 3, the embossing lane is having means to provide the said strip-like product the said desired shape and cross-section. Moreover, said apparatus is characterized so the said thermoplastic material to be embossed is passing longitudinally throughout said gradually circular embossment lane in the manner said strip-like product is obtained. Auxiliary rolls (400a-d) having an axle in communication with the construction board (401) enable said cooperated belt to role in its course so the desired embossing lane shell steadily comprises its predetermined characteristics. The radius of the auxiliary rolls (400a-d) is preferably more than 150 times more than the thickness of the aforementioned belt.

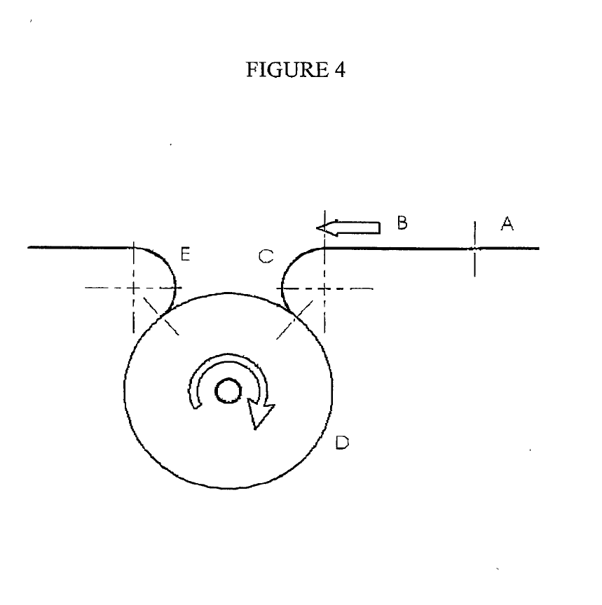

Reference is made now to FIG. 4, showing the various segments whereat the strip-like product is forced to follow: segment A is denoted for the step of obtaining viscoelastic melt from the extruder; segment B is denoted for the step of cooling; segment C is denoted for the step of driving the melt by air; segment D is denoted for the step of forming the strip shape by the forming roll and simultaneously cooling the melt. Throughout segment E the product is pushed for further processing steps.

It is acknowledged that according to one preferred embodiment of the present invention, an apparatus comprising an embossing lane of about 270° degrees (measured on the forming roll) the obtained linear velocity of the said strip in process is about 100 meter per minute and the reflected dwell time (Td) is about 0.6 second, wherein the corresponded Td in a commercial available cooperated forming rolls is no more then 0.2 second.

It is further acknowledged that the weight of a given segment of the aforementioned strip like product is not changed along its length more than about 10%. In this case, the heat transfer rate of the molten material is uniform along the product. Moreover, the shrinkage rate and the practical dimensions of the obtained product are provided gradually uniform.

Suitable thermoplastic material is selected, yet not limited to copolymers, grafts or blends comprising any suitable resins and/or rubbers, polyamides and nylons; polyolefin; polyurethane; polysulfone, polycarbonate and polyesters and all kind of mixture thereof.

1. An apparatus usefull for a continuous processing of thermoplastic materials to form strip-like products having a predetermined shape and cross section, comprising;
i. at least one forming roll,
ii. at least one cooperated belt; wherein said apparatus comprising means to roll said cooperated belt adjacent to more than 20° of the outer circumference of said forming roll, so the inner circumference of said cooperated belt and tile said outer circumference of the forming belts are defining a gradually circular embossing lane; and so said thermoplastic material to be formed is passing longitudinally throughout said gradually circular embossing lane in the manner said strip-like product is obtained with the predetermined shape and cross section.

2. The apparatus according to claim 1, comprising means to regulate the temperature of the strip-like product along its course in the circular embossing lane, wherein the product is cooled to about its solidification state along said embossing lane at the time it rotates throughout said embossing lane.

3. The apparatus according to claim 1, wherein the cooperated belt engages 180° to 320° of the outer circumference of the forming roll.

4. The apparatus according to claim 1, wherein the cooperated belt engages 220° to 280° of the outer circumference of the forming roll.

5. The apparatus according to claim 1, wherein the cooperated belt engages about 270° of the outer circumference of the forming roll.

6. The apparatus according to claim 1, wherein the strip-like product is changing its physical state along the embossing lane.

7. The apparatus according to claim 1, wherein the temperature control along the embossing lane is enabled by the continuous belt.

8. The apparatus according to claim 1, wherein the temperature control along the embossing lane is enabled by the forming roll.

9. The apparatus according to claim 1, wherein a feed of extruded thermoplastic material is forced to pass throughout the embossing lane.

10. The apparatus according to claim 1 wherein the thermoplastic material is processed at the embossing lane in its solidification state.

11. The apparatus according to claim 1 comprising at least two embossing lanes; characterized by a forming cycle comprising means to pull the viscoelastic product at the time it exits out from the extruder; to dry said viscoelastic material, to form to emboss said material and simultaneously, to cool said strip-like material to about its solidification state.

12. The apparatus according to claim 1, additionally comprising means to decrease the temperature of the embossed strip-like product below its solidification temperature.

13. The apparatus according to claim 1 adapted to reinforce the obtained strip-like product by at least one sheet member or cable adapted to attach the said strip-like product chemically or physically in the manner that both the thermoplastic material to be embossed and the said reinforcing means are allowed to pass together in the gradually circular embossing lane so hybrid or laminated reinforced product is obtained.

14. The apparatus according to claim 1, additionally having means to form a trimmed strip-like product.

15. The apparatus according to claim 1, wherein said trim is selected from a logo, lettering or any predetermined artistic feature.

16. The apparatus according to claim 1, adapted to produce ingredients of a drip emitter, additionally having means to form a strip-like product comprising plurality of water conduits.

17. The apparatus according to claim 1, wherein each of the water conduits comprising at least one-plurality inlet nozzles, pressure reducing pathways, and outlet nozzles.

18. The apparatus according to claim 1, having a plurality of forming rolls, engaged by at least one cooperated endless belt, heaving means to produce more then one strip-like product at the time.

19. The apparatus according to claim 1, useful for the production of drip irrigation strips.

20. The apparatus according to claim 1, useful for the production of drip irrigation strips adapted to be installed in the inner side of a tube.

21. The apparatus according to claim 1, useful for the production of drip irrigation strips, adapted to be folded to form an irrigation tube.

22. A strip-like product made of thermoplastic material formed by means of the apparatus defined in claim 1 or in any of the preceding claims.

23. A strip-like strip product made of thermoplastic material formed by the apparatus defined in claim 1 or in any of the preceding claims; wherein the tile weight of the cross-section of said product is not changed along its length more than about 10%.

24. A drip irrigation emitter formed by means of the apparatus defined in claim 1 or in any of the preceding claims.

25. A method for processing thermoplastic material having a plastic state by the apparatus defined in claim 1 or in any of the preceding claims comprising; pushing the said material throughout a gradually circular course of the embossing lane while cooling it to its solidification state, so a strip-like product is obtained.

26. The method for forming a trim strip-like product according to claim 1, additionally comprising the step of forming said trim in the embossing lane before a significant cooling of the thermoplastic material in process.

27. The method according to claim 25, comprising;
a. obtaining extruded viscoelastic melt;
b. drying said melt;
c. forming said melt by simultaneously
i. embossing by means of the forming role and the continuous belt;
ii. cooling said formed material to below its melting temperature; and
iii. pulling said material under controlled tension.

28. The method according to claim 25, additionally comprising the step of controlling the tension of the obtained strip-like product after it exits the forming rolls.
